(19) United States
(12) Patent Application Publication
(10) Pub. No.: US 2010/0126426 A1
(43) Pub. Date: May 27, 2010

(54) Apparatus for Storing and Transporting Small Reptiles and Amphibians

(76) Inventor: Michele Lauenstein, Mequon, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 12/276,144

(22) Filed: Nov. 21, 2008

(51) Int. Cl. A01K 1/00; G09F 3/00

(52) U.S. Cl. 119/453; 40/306

(57) ABSTRACT

A system and apparatus for storing and transporting small amphibians and reptiles comprised of a housing and novel a lid net member made from a spherical piece of die cut mesh attached to a reinforced border hem which accommodates a draw string, and which further includes a selectively attached net component, said net component having a handle which is anthropometrically proportioned for grasping by a child over the age of three.

### FIELD OF INVENTION

This invention relates to containers for animals, and more specifically to a device for storing and transporting small amphibians to be captured and observed, primarily by children of ages 3-12.

### BACKGROUND

Many children enjoy observing and catching insects and small amphibians. Frog-catching is a particularly popular activity. A recent Internet search revealed several web sites devoted to the subject of catching and storing frogs. Exemplary sites, such as http://www.everything2.com/index.pl?node_id=1482668, http://www.fishpondinfo.com/frog3.htm, and http://salamandercandy.wordpress.com/2007/04/25catch-frogs-release-toed-part-i/ describes the frog catching process, recommended supplies and tips.

For example, the site http://www.ehow.com/how_{—}2059662_catch-frog.html tells readers how to attract and corner a frog, capture it with bare hands, and store it in a high sided container with air holes. The site http://www.wikihow.com/Catch-a-Frog, tells readers to make a container for frog by gathering the following: a container with water (water optional); food for the frog or toad; some habitat (i.e. grass, a rock maybe, sticks); and, a lid with holes so the frog/toad can breathe. Finally, the site, http://everyfroghasastory.tripod.com/otheroptions.html warns readers to have patience because catching frogs may take hours or even days.

An Internet search also revealed that the search term “frog” is entered into search engines in the United States more than 2,000 times per day. The frequency of such a search, in combination with the number of sites dedicated to frog catching information, exhibits public interest pertaining to frog catching.

While the general method of catching frogs and small amphibians is well-known in the art, it has a number of drawbacks. Many households may not have suitable containers of the right size with lids on hand. Parents may not have the time to search for such containers, and may not want to purchase unwanted products solely for the purposes of obtaining a container which may be adapted to frog catching. This problem is compounded when there are multiple children who want to participate in frog-catching, requiring their parents to scramble for several containers.

Additionally, it is a safety hazard to direct children, and even adults, to poke holes into a lid with a sharp object, and adapting containers in this matter can create jagged edges and structures that pose hazards to children and the captured reptiles and amphibians. Containers may require varying degrees of force to penetrate them, and it is difficult to gauge whether enough holes or slits have been made to provide sufficient air to the frog or small amphibian.

It is therefore desirable to have a container of a size and shape adapted to storing and transporting frogs or other small amphibians which can be inexpensively purchased and does not requiring the piercing of air holes.

It is further desirable to have a container which is reusable, intended to be kept for a long a period of time and which is aesthetically appealing.

Minnow buckets are well known in the art, but are not adapted for use by children, with applicable dimensions and safety considerations in mind. Children require light weight containers which can be easily opened and closed, and with handles of a dimension suited to their hand size. Further, it is desirable to have a frog catching device which can be offered for sale and which meets all applicable child safety standards.

Additionally, retailers, resorts and educational suppliers currently do not offer containers adapted for frog catching, which can be conveniently purchased from a store or online without inconvenient preparation or adaptation by parents.

As defined herein a “small amphibian” or “small reptile” refers to a four-legged, cold-blooded vertebrate. Small amphibians include, but are not limited to, frogs, toads, newts and salamanders.

As defined herein a “frog catching” refers to the act of catching frogs, or any small amphibian which may be substituted for a frog, to engage in a variation of the activity, using methods known in the art for catching frogs and small amphibians.

### BRIEF DESCRIPTION OF DRAWINGS

FIG. 1 illustrates a side view of an exemplary embodiment of an apparatus for storing and transporting small reptiles and amphibians.

FIG. 2 illustrates a side view of an exemplary embodiment of an apparatus for storing and transporting small reptiles and amphibians which further includes an optional net member.

### SUMMARY OF INVENTION

The invention disclosed herein is an apparatus for storing and transporting a small amphibian or small reptile which includes a light weight housing having a bottom wall and a generally cylindrical upper housing wall, a lid net member comprised of a spherical piece of die cut mesh attached to a reinforced border hem which accommodates a draw string and a selectively attached net component, wherein the draw string is run through a reinforced hem attached to netting and is adjusted to be tightened, loosened, secured and removed by a securing component such as a plastic buckle, metal loop or other structure. Various embodiments of the invention may further include a net component having a handle which is anthropometrically proportioned for grasping by a child over the age of three. Still other embodiments may include a ridge or protuberance which spans said generally cylindrical upper housing wall to add structural support and/or further secure said lid net member.

### Exemplary Embodiments of the Invention

For the purpose of promoting an understanding of the present invention, references are made in the text hereof to embodiments of an apparatus for storing and transporting small amphibians, only some of which are depicted in the figures. It should nevertheless be understood that no limitations on the scope of the invention are thereby intended. One of ordinary skill in the art will readily appreciate that modifications such as the dimensions, size, and shape of the components, alternate but functionally similar materials from which the apparatus for storing and transporting small amphibians is made, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed apparatus or manner.

It should be understood that the drawings are not necessarily to scale, emphasis instead being placed upon illustrating the principles of the invention. In addition, in the embodiments depicted herein, like reference numerals in the various drawings refer to identical or near identical structural elements.

Moreover, the term “substantially” or “approximately” as used herein may be applied to modify any quantitative representation that could permissibly vary without resulting in a change in the basic function to which it is related. For example, one embodiment of the apparatus for storing and transporting amphibians is disclosed herein as including a general housing. The general housing might permissibly be a different height, or shape, and still be within the scope of the invention if its functionality is not materially altered.

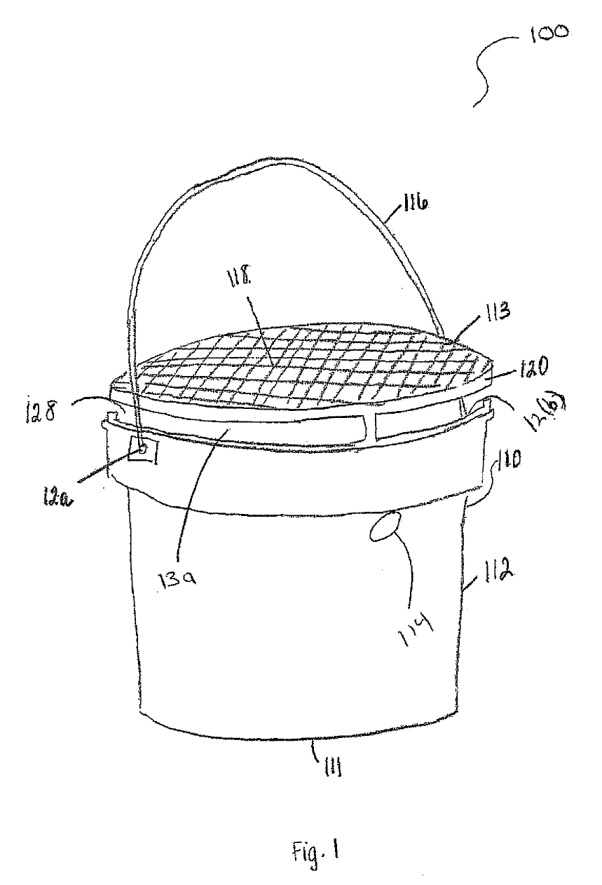

Referring now to the drawings, FIG. 1 is a front view of one exemplary embodiment of apparatus for storing and transporting small amphibians 100, which comprises a generally housing 110 having a flat bottom wall 111 and generally cylindrical top wall 112. Novel lid net member 113 is affixed to cylindrical top wall 112 by a hinge member 114. Additionally, in the embodiment shown, handle 116 is either pivotally or non-pivotally attached to top wall 112 at points 12a and 12b. In other embodiments housing 110 may be a shape other than cylindrical such as oval, square or conical, and handle 116 may be longer, shorter, have a different configuration for grasping, or may be omitted entirely. In the embodiment shown, lid net member 113 is a contoured piece of netting may of polyester, plastic, nylon, fiber, jute or canvass which is sufficiently strong to be durable and resist tearing, stretching, deformation, mildew and water damage, and which further an reinforced border hem 13a through which child-safe draw string 114 is threaded, gathering reinforced border hem 13a in an accordion-like manner.

Child-safe draw string 114 is secured to housing wall 113 by a string which is knotted around bucket handle 116, and by adjustable draw string component, which in the embodiment shown is a rigid plastic, wood, or metal member through which draw string 114 is pulled so that Novel lid net member 113 is tightened, loosened, secured and may be selectively attached or removed to upper edge of housing 110.

In the embodiment shown in FIG. 1, net-lid attachment member 13 is attached by a unique, child-safe draw string 114. In the embodiment shown child-safe draw string member is a pivotal mechanical hinge unit well known in the art, but in other embodiments may consist of snaps, screws, a hook and eye mechanism, or may be omitted entirely so that lid 113 is detached from cylindrical wall 112 and is molded to fit securely over cylindrical wall 112 in the manner of any container lid known in the art. In other embodiments, lid 113 may be affixed to cylindrical wall 112 by a rope or tether made of any material to prevent the lid from being lost.

In the embodiment shown, lid 113 is comprised of netting material 118, set within net frame 20. In other embodiments, but in other embodiments, lid 113 may be a screen of metal or plastic, or a traditional lid with any number, combination or configuration of apertures which effectively allows sufficient air to enter the apparatus for storing and transporting small amphibians 100.

In the embodiment shown, housing 110 is made of a lightweight plastic, but in other embodiments, may be made of galvanized metal provided such materials are water-resistant, non-toxic and capable of being inexpensively molded or machined. In other embodiments, housing 110 may be constructed from a recyclable material

In other embodiments, housing 110 may be physically adapted to facilitate stacking or storage. Housing 110 may be further adapted to permit the affixation of graphics or information, such as educational or instructional information about storing, transporting and maintaining frogs and small amphibians. Housing 110 may be further adapted for marking, writing, painting or affixing stickers to permit labeling and ornamentation.

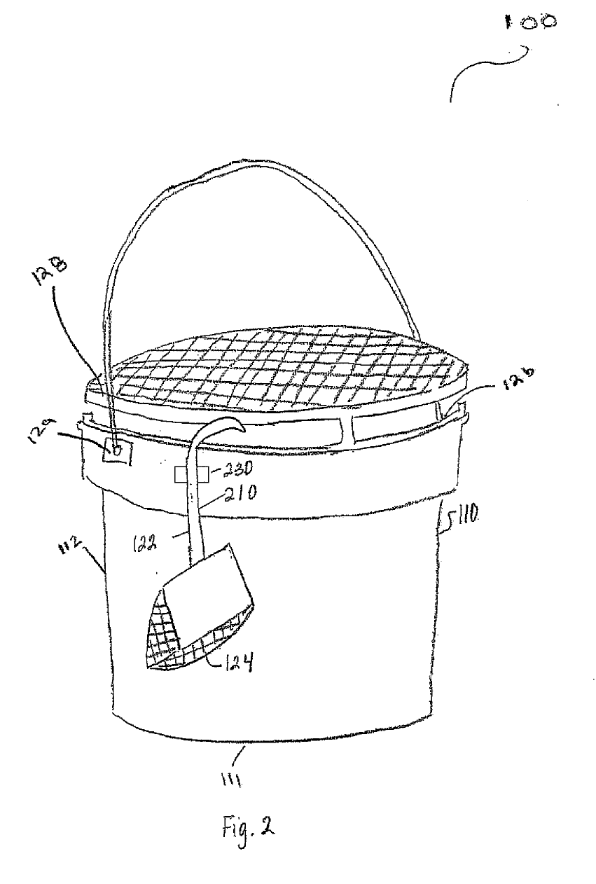

Referring now to the drawings, FIG. 2 depicts a front view of and additional embodiment of apparatus for storing and transporting small amphibians 100, which comprises a generally housing 110, which further includes catching net 210 which is an ordinary net comprised of handle portion 116 and net portion 122 commonly known in the art, but which is adapted so that handle portion 116 is of a height suited to children and further suited to be conveniently attached to apparatus for storing and transporting small amphibians 100 by affixation means 230. In the embodiment shown, affixation means 230 is a plastic brace affixed to housing 110 or singly molded with housing 110, into which handle portion 116 securely fits. In other embodiments, affixation means 230 may be adhesive, a snap, bolt, Velcro, a hook, a string or tether, or other means which connects catching net 210 housing 110. In other embodiments, catching net 210 may be detached but sold has part of a kit.

In the embodiment shown, housing 110 is made of a lightweight plastic which is food safe, but in other embodiments, may be made of galvanized metal provided such materials are water-resistant, non-toxic and capable of being inexpensively molded or machined. In other embodiments, housing 110 may be constructed from a recyclable material, or a material which is particularly durable so as to preserve housing 110 and any images affixed thereto as an heirloom or collectible item.

In various embodiments, housing 110 may be physically adapted to facilitate stacking or storage. Housing 110 may be further adapted to permit the affixation of graphics or information by heat screening, painting or with an adhesive. Such images may be water-resistant, heat-resistant. Additionally, housing 110 may be completely or partially fluorescent

Referring now to the drawings, FIG. 2 depicts a front view of and additional embodiment of apparatus for storing and transporting small amphibians 100, which comprises a generally housing 110, which further includes catching net 210 which is ordinary net comprised of handle portion 122 and net portion 124 commonly known in the art, but which is adapted so that handle portion 122 is of a height-suited to children and further suited to be conveniently attached to apparatus for storing and transporting small amphibians 100 by affixation means 230, and which is anthropometrically proportioned and contoured to be grasped easily by small children. In various embodiments, handle portion 122 may include frictional components, curvature and ridges for finger placement.

In the embodiment shown, affixation means 230 is a plastic brace affixed to housing 110 or singly molded with housing 110, into which handle portion 122 securely fits. In other embodiments, affixation means 230 may be adhesive, a snap, bolt, Velcro, a hook, a string or tether, or other means which connects catching net 210 housing 110. In other embodiments, catching net 210 may be detached but sold has part of a kit.

What is claimed is:

1. An apparatus for storing and transporting at least one small amphibian or at least one small reptile comprising:
a light weight housing having a bottom wall and generally cylindrical upper housing wall;
a lid net member comprised of a spherical piece of die cut mesh attached to a reinforced border hem which accommodates a draw string; and
a selectively attached net component, said net component having a handle which is anthropometrically proportioned for grasping by a child over the age of three.

2. The apparatus of claim 1 which further includes a ridge which spans said generally cylindrical upper housing wall to add structural support

3. The apparatus of claim 1 which further includes at least one protuberance from said generally cylindrical upper housing wall to further secure said lid net member.

4. The apparatus of claim 1 which further includes a water-resistant image and educational information affixed to said generally cylindrical upper housing wall.

5. The apparatus of claim 1 wherein said lid net member includes a seam through which a draw string is tightened to secure said lid net member.

6. The apparatus of claim 5 which further includes a securing member used to tighten and release said draw string used to secure said lid net member to said generally cylindrical upper housing.

7. The apparatus of claim 1 wherein said selectively attached net component includes a hook-shaped handle adapted to be suspended from the upper portion of said generally cylindrical housing.

8. The apparatus of claim 7 wherein said hook shaped handle is secured to said generally cylindrical upper housing by a selective attachment means which allows said hook shaped handle to be secured to said upper portion of said generally cylindrical housing when said net is not in use, said net attachment means selected from a group consisting of a loop, clasp, string, Velcro, fastener, lip or rack.

9. The apparatus of claim 8 wherein said hook shaped handle is of a length between three and seven inches, measured from the attachment point of said net frame to said terminal end of said hook shaped handle.

10. The apparatus of claim 1 wherein said lid net member is made from die cut mesh configured in a generally spherical shape and attached to a reinforced border hem which accommodates a draw string.

11. An system for storing and transporting a small amphibian or small reptile comprising:
a light weight housing having a bottom wall and generally cylindrical upper housing wall;
a lid net member comprised of the apparatus of claim 1 wherein said lid net member is made from a spherical piece of die cut mesh attached to a reinforced border hem which accommodates a draw string;
and a selectively attached net component, said net component having a handle which is anthropometrically proportioned for grasping by a child over the age of three.

12. The system of claim 11 which further includes a ridge which spans said generally cylindrical upper housing wall to add structural support

13. The system of claim 11 which further includes at least one protuberance from said generally cylindrical upper housing wall to further secure said lid net member.

14. The system of claim 11 which further includes a water-resistant image and directions for use which may be personalized and selectively attached to said generally spherical upper housing wall.

15. The apparatus of claim 11 wherein said lid net member includes a seam through which a draw string is tightened to secure said lid net member.

16. The apparatus of claim 15 which further includes a securing member used to tighten and release said draw string used to secure said lid net member to said generally cylindrical upper housing.

17. The apparatus of claim 11 wherein said selectively attached net component includes a hook-shaped handle adapted to be suspended from the upper portion of said generally cylindrical housing.

18. The apparatus of claim 17 wherein said hook shaped handle is secured to said generally cylindrical upper housing by a selective attachment means which allows said hook shaped handle to be secured to said upper portion of said generally cylindrical housing when said net is not in use, and said net attachment means may include a loop, clasp, string, Velcro, fastener, lip or rack.

19. The apparatus of claim 8 wherein said hook shaped handle is of a length between three and seven inches, measured from the attachment point of said net frame to said terminal end of said hook shaped handle.

20. An apparatus for storing and transporting a small amphibian or small reptile comprising:
a light weight housing having a bottom wall and generally cylindrical upper housing wall;
a lid net member comprised of the apparatus of claim 1 wherein said lid net member is made from a spherical piece of die cut mesh attached to a reinforced border hem which accommodates a draw string;
a selectively attached net component, said net component having a handle which is anthropometrically proportioned for grasping by a child over the age of three and which includes hook shaped portion that may be secured to said generally cylindrical upper housing.
